(19) United States
(12) Patent Application Publication
(10) Pub. No.: US 2018/0180194 A1
(43) Pub. Date: Jun. 28, 2018

(54) SOLENOID VALVE

(71) Applicant: UNICK CORPORATION, Gyeongsangnam-do (KR)

(72) Inventors: Chang-Hoon Lee, Gyeongsangnam-do (KR); Eui-Dong Roh, Busan (KR); Jeong-Tae Kim, Jeollanam-do (KR); Chan-Shik Ahn, Gyeongsangnam-do (KR); Tae-Hyeon Kim, Busan (KR)

(21) Appl. No.: 15/855,469

(22) Filed: Dec. 27, 2017

(30) Foreign Application Priority Data
Dec. 28, 2016 (KR) 10-2016-0180641

(51) Int. Cl. F16K 31/06; F16H 61/02

(52) U.S. Cl. CPC F16K 31/0655; F16H 2061/0253; B60Y 2400/4045; F16H 61/0251

(57) ABSTRACT

A solenoid valve includes a valve that regulates the entrance and exit of oil, and a solenoid that operates the valve. The valve includes a hollow holder extending in one direction, ports including a supply port, a control port, and a discharge port, a passage that is formed in the holder and extends in the longitudinal direction of the holder, wherein a chamber connecting the supply port and the discharge port is formed in the middle of the passage, a spool movably installed in the passage, a channel that is formed in the spool and has one end connected to the control port and the other end connected to the chamber, a control land that divides the chamber into a supply chamber and a discharge chamber, and a spring that is installed between the holder and the spool to elastically support the spool.

### CROSS-REFERENCE TO RELATED APPLICATIONS

This application claims the priority of Korean Patent Application No. 10-2016-0180641 filed on Dec. 28, 2016, in the Korean Intellectual Property Office, the disclosure of which is hereby incorporated by reference in its entirety.

### BACKGROUND

### 1. Technical Field

The present disclosure relates to a solenoid valve and more particularly, to a solenoid valve installed in an engine or a power train of an automobile to regulate the flow of a fluid such as fuel or oil or control a hydraulic pressure.

### 2. Description of the Related Art

Generally, a solenoid valve is installed in a power train including an engine of an automobile to regulate the flow of a fluid such as fuel or oil or control the pressure of the fluid. For example, the solenoid valve is used to control the supply and injection of fuel in a fuel system, control the circulation for lubrication and cooling in a cooling system, and control a pressure in a power transmission system.

The solenoid valve for pressure control may be classified into a spool type solenoid valve, a ball type solenoid valve and a poppet type solenoid valve according to its internal structure. Among them, the spool type solenoid valve is widely used because of its simple structure and easy pressure control.

Korean Patent Registration No. 10-1093452 (issued at Dec. 7, 2011) discloses a spool type solenoid valve for adjusting the hydraulic pressure of an automatic transmission.

The solenoid valve disclosed in this patent includes a valve that is operated by a solenoid at the time of power-on to regulate the flow of oil. The valve includes a holder having a plurality of ports for the entrance and exit of oil, and a spool movably installed inside the holder and selectively connecting the ports. At this time, a feedback port, a feedback chamber and a feedback channel for feeding back some of the oil to control the movement of the spool are formed in the holder.

However, since the conventional feedback channel is located on the outer peripheral surface of the holder and is opened to the outside, if the holder is not closely attached to a mounting hole at the time of installing the solenoid valve, an appropriate feedback pressure is not generated in the feedback chamber. This may cause a problem that the movement of the spool and the discharge pressure of the oil cannot be smoothly controlled.

### SUMMARY

The present disclosure has been made to solve the above problem of the conventional art and it is an object of the present disclosure to provide a solenoid valve capable of reliably controlling a hydraulic pressure discharged to an automatic transmission and linearly controlling a change in hydraulic pressure according to an electric current applied to a solenoid.

In accordance with one aspect of the present disclosure, a solenoid valve includes a valve that regulates the entrance and exit of oil, and a solenoid that operates the valve.

The valve includes a hollow holder extending in one direction, ports including a supply port formed in the middle of the holder, a control port formed at one end of the supply port, and a discharge port formed at the other end of the supply port, a passage that is formed in the holder and extends in the longitudinal direction of the holder, wherein a chamber connecting the supply port and the discharge port is formed in the middle of the passage, a spool movably installed in the passage, a channel that is formed in the spool and has one end connected to the control port and the other end connected to the chamber, a control land that divides the chamber into a supply chamber and a discharge chamber, and a spring that is installed between the holder and the spool to elastically support the spool.

According to embodiments of the present disclosure, when the spool is moved, the other end of the channel is positioned on the supply chamber or the discharge chamber to connect the control port to the supply port or the discharge port. For example, when power is applied and the spool rises by the solenoid, the other end of the channel is positioned on the supply chamber and the control port is connected to the supply port. At this time, the oil introduced through the supply port is fed to the control port through the channel and the movement of the spool is controlled by pressing the spool in the course of feed of the oil.

That is, since the channel plays a role of a connecting path for transferring the oil and a feedback path for pressing the spool, the hydraulic pressure discharged to an automatic transmission can be reliably controlled.

In addition, since the channel is formed in the spool and there is no possibility of leaking of oil during the feeding of the oil, the change in hydraulic pressure according to an electric current applied to the solenoid can be linearly controlled.

### BRIEF DESCRIPTION OF DRAWINGS

FIGS. 1 and 2 are sectional views of a solenoid valve according to an embodiment of the present disclosure, taken in different directions.

FIG. 3 is a sectional view taken along line A-A in FIG. 2.

FIG. 4 is a view showing a modification of a solenoid according to an alternate embodiment of the present disclosure.

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed descriptions of well-known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

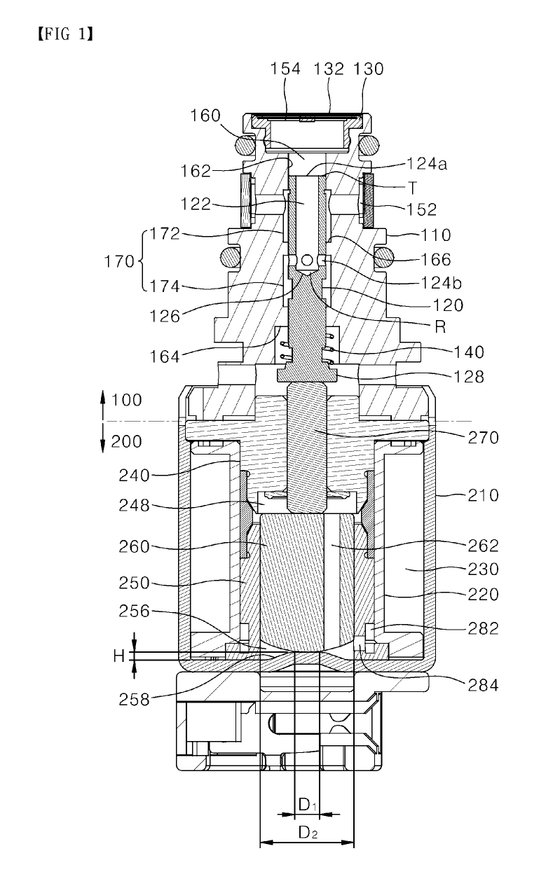

A solenoid valve according to an embodiment of the present disclosure is a hydraulic device for controlling oil supplied from an external hydraulic pressure source to a predetermined pressure and then supplying the oil to a clutch (not shown) side of an automatic transmission. As shown in FIGS. 1 and 2, the solenoid valve includes a valve 100 for regulating the entrance and exit of oil and a solenoid 200 for operating the valve 100.

The valve 100 will now be described with reference to FIGS. 1 and 2.

The valve 100 includes a holder 110, a spool 120 movably installed in the holder 110, a cap 130 coupled to the upper end of the holder 110, and a spring 140 installed between the holder 110 and the spool 120.

The holder 110 is formed with a hollow extending in one direction (vertical direction in the figures). A supply port 152 for supplying oil from the outside is formed in the middle of the holder 110 and a discharge port 156 for discharging the oil recovered through a control port 154 to the outside is formed below the supply port 152. The control port 154 is formed at the center of the cap 130, as a port through which the oil controlled to the predetermined pressure is discharged.

A passage 160 connecting the supply port 152, the control port 154 and the discharge port 156 is formed in the holder 110. The passage 160 extends in the longitudinal direction of the holder 110 and a chamber 170 having a larger diameter than the passage 160 is formed at the middle of the passage 160.

Three lands 162 to 166 are formed in the inner wall of the passage 160. Guide lands 162 and 164 for guiding the movement of the spool 120 are formed at the upper and lower ends of the passage 160 and a control land 166 for partitioning the chamber 170 is formed at the middle of the passage 160. The control land 166 is located in the middle of the chamber 170 to partition the chamber 170 into a supply chamber 172 and a discharge chamber 174.

The spool 120 is a shaft extending in the longitudinal direction of the holder 110. A channel 122 connecting the control port 154 and the chamber 170 is formed in the spool 120. The channel 122 extends from the upper end of the spool 120 to the middle thereof and is connected to the control port 154 and the chamber 170 via a first opening 124a and a second opening 124b provided at both ends, respectively. At this time, the first opening 124a is positioned at the upper end of the spool 120, the second opening 124b is positioned at the middle of the spool 120, and the second opening 124b passes through the middle of the spool 120 such that the second opening 124b is perpendicular to the channel 122. The bottom surface 126 of the channel 122 is formed below the second opening in a conical shape that becomes narrower toward the bottom surface.

The thickness of the upper end of the spool 120, in other words, the thickness T of the spool 120 excluding the channel 122, is preferably 40% of the radius of the spool 120 and the radius R of the bottom surface 126 of the channel 122 is preferably 70% of the radius of the spool 120.

When the thickness of the spool 120 and the radius of the bottom surface 126 are made at the above-mentioned percentages of the radius of the spool 120, a feedback pressure by oil fed through the channel 122 can be appropriately controlled. For example, when the thickness of the spool 120 and the radius of the bottom surface 126 are lower than the above-mentioned percentages, the feedback pressure applied to the spool 120 is reduced so as not to linearly control the oil discharged through the control port 154. On the other hand, when the thickness of the spool 120 and the radius of the bottom surface 126 are higher than the above-mentioned percentages, the feedback pressure applied to the spool 120 is increased, which requires much power when the spool 120 is moved.

The second opening 124b of the channel 122 is formed at a position corresponding to the control land 166. As the spool 120 is moved, the second opening 124b is located at the upper portion or the lower portion of the control land 166 to connect the control port 154 to the supply port 152 or the discharge port 156. For example, when the spool 120 rises, the second opening 124b is positioned on the supply chamber 172 to connect the control port 154 to the supply port 152. On the other hand, when the spool 120 falls, the second opening 124b is positioned on the discharge chamber 174 to connect the control port 154 to the discharge port 156.

On the other hand, the amount of opening of the second opening 124b is adjusted by the control land 166 in accordance with the position of the spool 120. Accordingly, when the movement of the spool 120 is controlled, the opening amount of the second opening 124b can be adjusted. At this time, the diameter of the second opening 124b and the thickness of the control land 166 are formed at a ratio of 1.1:1.3. That is, the thickness of the control land 166 is formed to be larger, which prevents the control port 154 from being connected to the supply port 152 and the discharge port 156 at the same time, thereby preventing oil from leaking to the discharge port 156 in the course of oil feeding. This can improve the hydraulic efficiency and prevent a sudden change (overshoot or undershoot) of the hydraulic pressure.

The cap 130 is in the form of a multi-stage disc coupled to the upper end of the holder 110. The control port 154 is formed at the center of the cap 130 and a filter 132 for removing foreign substances is installed in the control port 154.

The spring 140 is installed between the guide land 164 of the holder 110 and a flange 128 of the spool 120 to elastically support the spool 120 downward.

The solenoid 200 will be described with reference to FIGS. 1 and 2.

The solenoid 200 includes a hollow case 210, a bobbin 220 installed inside the case 210, a coil 230 wound on the outer circumferential surface of the bobbin 220, a core 240 and a yoke 250 respectively coupled to the upper end and lower end of the bobbin 220, a plunger 260 movably installed in the yoke 250, and a rod 270 which penetrates the core 240 and is disposed between the plunger 260 and the spool 120.

The upper end of the case 210 is opened and the lower end thereof is in the form of a closed cup. The upper end of the case 210 is caulked so as to surround the lower end of the holder 110. When the upper end of the case 210 is caulked, the valve 100 is pressed to the solenoid 200 to closely contact the components 220 to 270 installed in the case 210. This prevents the components 220 to 270 installed in the case 210 from being moved to prevent foreign substances from being introduced into the upper portion of the case 210.

The bobbin 220 has a hollow spool shape. The bobbin 220 is made of an insulating material and interrupts electrical connection between the coil 230 wound on the outer circumferential surface of the bobbin 220 and the core 240, the yoke 250 and the plunger 260 installed inside the bobbin 220.

The coil 230 generates a magnetic field when an electric current is applied. The magnetic field generated in the coil 230 is induced by the core 240 and the yoke 250 to lift the plunger 260. At this time, the intensity of the magnetic field is proportional to the intensity of an electric current flowing along the coil 230 and the number of coils 230 wound on the bobbin 220. Therefore, the stronger magnetic field is generated with the larger current flowing in the coil 230 or the more number of coils 23 so as to reliably control the movement of the plunger 260.

The core 240 and the yoke 250 are fixed iron cores for inducing a magnetic field generated in the coil 230.

The core 240 is coupled to the upper portion of the bobbin 220 with a part thereof inserted in the bobbin 220. A predetermined insertion space 248 is formed in the lower surface of the core 240 inserted in the bobbin 220 so that the plunger 260 can be lifted.

The yoke 250 is coupled to the lower portion of the bobbin 220 with a part thereof inserted into the bobbin 220. A working space 256 in which the plunger 260 is movably installed is formed in the yoke 250. At this time, a spacing projection 258 for spacing the plunger 260 is formed in the bottom surface of the case 210.

The spacing projection 258 minimize the area of contact with the case 210 to block the flow of the magnetic field through the bottom of the case 210 to the plunger 260, thereby allowing the plunger 260 to move smoothly. At this time, the diameter D1 of the spacing projection 258 is preferably 0.34 to 0.4 times the diameter D2 of the working space 256 and the height H of the spacing projection 258 is preferably 0.3 times the diameter of the working space 256.

When the spacing projection 258 is formed with the above-mentioned dimensions, it is possible to surely block a reverse magnetic force (the flow of the magnetic field extending to the plunger 260 through the bottom of the case 210) and prevent the plunger 260 from sticking in a small current section, which can improve the operability of the plunger 260.

An annular groove 282 is formed on the outer circumferential surface of the yoke 250. A first connection hole 284 connecting the working space 256 and the annular groove 282 is formed at one side of the yoke 282. A second connection hole 286 connecting the annular groove 282 to the outside is formed on the inner circumferential surface of the bobbin 220.

According to the above-described annular groove 282 and the connection holes 284 and 286, when the plunger 260 falls, the oil in the working space 256 is discharged through the first connection hole 284, the annular groove 282 and the second connection hole 286 to the outside. On the other hand, when the plunger 260 rises, a negative pressure is generated in the working space 256 and the oil that has been discharged to the outside is again introduced into the working space 256 through the second connection hole 286, the annular groove 282 and the first connection hole 284 by the negative pressure. Therefore, when the plunger 260 is moved, the pressure generated in the working space 256 can be sufficiently relieved through the annular groove 282 and the connection holes 284 and 286.

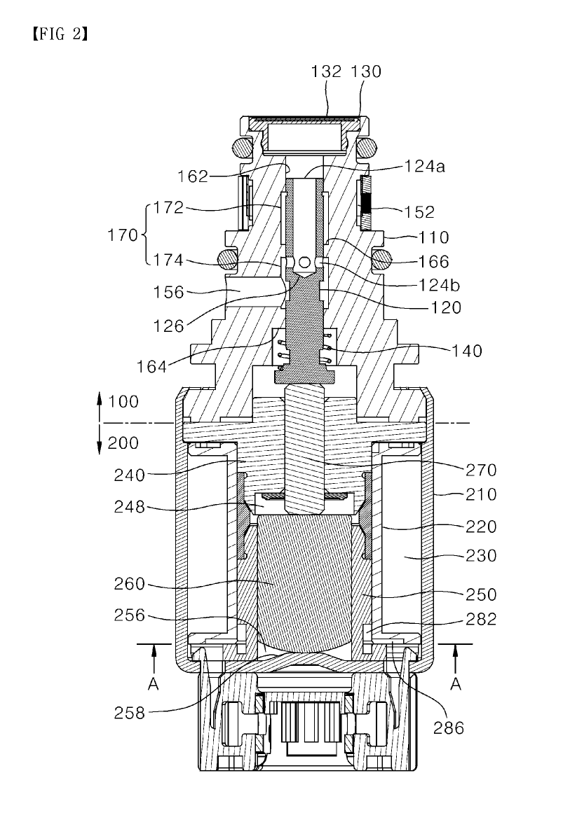

The annular groove 282 is annularly formed along the circumference of the yoke 250 and the first connection hole 284 and the second connection hole 286 are radially arranged in different directions along the circumference of the yoke 250. As shown in FIG. 3, in a state where the solenoid valve is installed, the first connection hole 284 faces upward while the second connection hole 286 faces the opposite side. Therefore, the foreign matter contained in the oil and introduced from the outside when the plunger 260 rises is accumulated in the lower portion of the annular groove 282 due to its own weight while the oil is being fed along the annular groove 282, which eliminates a possibility of introduction of the oil into the working space 256 (see FIG. 3).

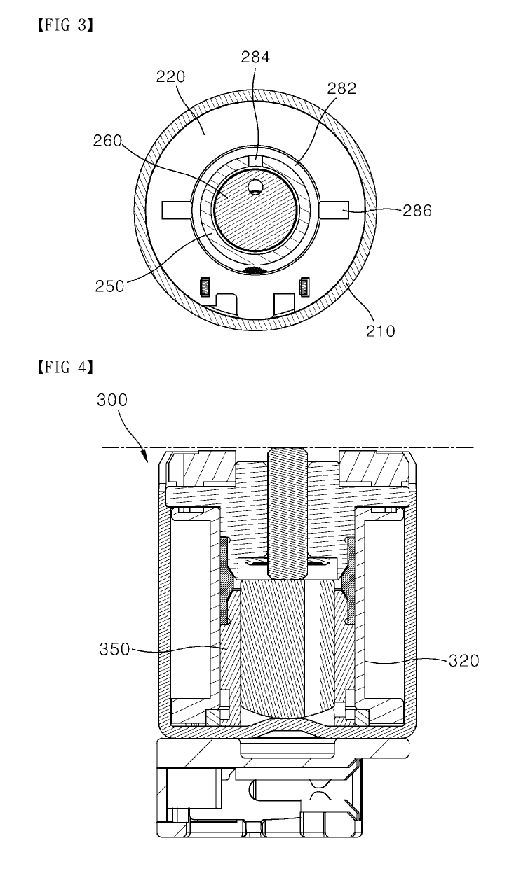

FIG. 4 shows a modification of the solenoid according to the embodiment of the present disclosure.

The solenoid 200 according to the above-described embodiment and a solenoid 300 according to a modification of the embodiment have yokes 250 and 350 of different structures coupled to lower portions of bobbins 220 and 320, respectively. That is, the yoke 250 according to the embodiment is inserted into the bobbin 220 and the flange formed around the lower end is coupled to the lower surface of the bobbin 220, while the yoke 350 according to the modification is entirely inserted into the bobbin 320.

In this manner, when the yoke 350 is inserted into the bobbin 320, the yoke 350 can be installed after the bobbin 320 is assembled, thereby improving assemblability. In addition, since the yoke 350 is inserted into the bobbin 320, the coaxiality between the bobbin 320 and the yoke 350 can be improved.

The plunger 260 is a movable iron core reciprocating by the magnetic field generated in the coil 230. The plunger 260 is movably installed in the working space 256. A through-hole 262 is formed in the plunger 260 to allow the oil to flow between the insertion space 248 and the working space 256 when the plunger 260 is moved.

The volume of the lower working space 256 of the plunger 260 changes when the plunger 260 is moved. When an electric current supplied to the solenoid 300 is interrupted to lower the plunger 260, the volume of the working space 256 is minimized. When the current is supplied to the solenoid 200 to raise the plunger 260, the volume of the working space 256 is maximized. In this manner, when the amount of change in the volume of the working space 256 generated when the plunger 260 is moved is larger than the volume of the annular groove 282, the damping effect is generated by the oil filled in the working space 256. Therefore, shock and noise due to contact of the plunger 260 with the case 210 during the falling of the plunger 260 can be prevented.

If the lower surface of the plunger 260 is formed as a curved surface, the flow of the magnetic field directly extending to the plunger 260 through the bottom of the case 210 can be blocked more reliably. At this time, the radius of curvature of the lower surface of the plunger 260 is preferably 15 mm.

The rod 270 is a metal rod having a predetermined length. The rod 270 is interposed between the plunger 260 and the spool 120 to raise the spool 120 when the plunger 260 rises and lower the plunger 260 when the spool 120 falls. At this time, the rod 270 is installed to penetrate the core 240.

FIG. 1 shows a state in which no power is applied to the solenoid 200. The spool 120 is lowered by the spring 140 and the second opening 124b is located on the discharge chamber 174 to connect the control port 154 and the discharge port 156. Accordingly, the oil that has been discharged to the clutch side via the control port 154 is recovered to the control port 154 and then discharged to the outside via the discharge port 156.

On the other hand, when power is applied to the solenoid 200, the magnetic field generated in the coil 230 is induced by the core 240 and the yoke 250 to raise the plunger 260. The plunger 260 pushes up the rod 270 to raise the spool 120 and the second opening 124b is positioned on the supply chamber 172 by the raised spool 120. Accordingly, the control port 154 and the supply port 152 are connected and the oil supplied through the supply port 152 is discharged to the clutch side via the control port 154.

Here, the oil supplied through the supply port 152 is controlled to a predetermined pressure in the course of passing through the second opening 124b. That is, the pressure is adjusted in accordance with the amount of opening of the second opening 124b by the control land 166.

The oil introduced into the second opening 124b is fed to the control port 154 through the channel 122, in which course the upper end of the spool 120 and the bottom surface 126 of the channel 122 are pressed to form a feedback pressure. The feedback pressure acts in a direction of suppressing the rising of the spool 120 to control the rising speed of the spool 120. Therefore, the pressure of the oil discharged through the control port 154 can be linearly controlled and sudden fluctuation (overshoot or undershoot) of the hydraulic pressure can be prevented.

While the present disclosure has been particularly shown and described by way of exemplary embodiments thereof, the embodiments are just illustrative, but, on the contrary, it is to be understood by those skilled in the art that various modifications and changes may be made without departing from the spirit and scope of the present disclosure. Therefore, the scope of protection of the present disclosure should be construed by the claims rather than the specific embodiments and all technical ideas within equivalents thereof should be construed as being included in the scope of the present disclosure.

What is claimed is:

1. A solenoid valve comprising:
a valve that regulates the entrance and exit of oil; and
a solenoid that operates the valve,
wherein the valve includes:
a hollow holder extending in one direction;
a plurality of ports including a supply port formed in the middle of the holder, a control port formed at one end of the supply port, and a discharge port formed at the other end of the supply port;
a passage that is formed in the holder and extends in the longitudinal direction of the holder, wherein a chamber connecting the supply port and the discharge port is formed in the middle of the passage;
a spool movably installed in the passage;
a channel that is formed in the spool and has one end connected to the control port and the other end connected to the chamber,
a control land that divides the chamber into a supply chamber and a discharge chamber; and
a spring that is installed between the holder and the spool to elastically support the spool, and
wherein, when the spool is moved, the other end of the channel is positioned on the supply chamber or the discharge chamber to connect the control port to the supply port or the discharge port, respectively.

2. The solenoid valve according to claim 1, wherein a first opening is formed in the one end of the channel and is positioned on the upper end of the spool,
wherein a second opening is formed in the other end of the channel and is positioned on the middle of the spool; and
wherein the amount of opening of the second opening is adjusted by the control land when the spool is moved.

3. The solenoid valve according to claim 2, wherein the second opening penetrates the middle of the spool in such a manner that the second opening is perpendicular to the channel, and the bottom surface of the channel has a conical shape that becomes narrower toward the other end.

4. The solenoid valve according to claim 3, wherein a thickness of the one end of the spool is formed to be 40% of a radius of the spool and a radius of the bottom surface of the channel is formed to be 70% of the radius of the spool.

5. The solenoid valve according to claim 3, wherein a diameter of the second opening and a thickness of the control land are formed at a ratio of 1.1:1.3.

6. The solenoid valve according to claim 1, wherein the solenoid includes:
a hollow case having an opened upper end and a closed lower end;
a bobbin that is installed in the case and has a coil wound on the outer circumferential surface of the bobbin;
a core that is coupled to the upper portion of the bobbin and has an insertion space formed in the core;
a yoke that is coupled to the lower portion of the bobbin and has a working space formed in the yoke; and
a plunger that is installed in the working space and is moved up to the insertion space.

7. The solenoid valve according to claim 6, further comprising:
a spacing projection being formed in the bottom space of the case.

8. The solenoid valve according to claim 7, wherein the diameter of the spacing projection is formed to be 0.34 to 0.4 times the diameter of the working space and the height of the spacing projection is formed to be 0.3 times the diameter of the working space.

9. The solenoid valve according to claim 8, wherein the other end surface of the plunger is curved and the radius of curvature of the other end surface of the plunger is 15 mm.

10. The solenoid valve according to claim 6, further comprising:
an annular groove being formed on the outer circumferential surface of the yoke;
a first connection hole connecting the working space and the annular groove being formed in one side of the yoke; and
a second connection hole connecting the annular groove to the outside being formed in the inner circumferential surface of the bobbin, with the first connection hole and the second connection hole being arranged in different directions.

11. The solenoid valve according to claim 6, wherein, when the plunger is moved, an amount of change in a volume of the working space is larger than a volume of the annular groove.
